(19) United States
(12) Patent Application Publication
(10) Pub. No.: US 2007/0115361 A1
(43) Pub. Date: May 24, 2007

(54) Dual camera calibration technique for video projection systems

(75) Inventors: Mark T. Bolas, Mountain View, CA (US); Ian E. McDowall, Mountain View, CA (US)

Correspondence Address: Crockett & Crockett, Suite 400, 24012 Calle De La Plata, Laguna Hills, CA, 92653, US

(73) Assignee: Fakespace Labs, Inc.

(21) Appl. No.: 11/166,897

(22) Filed: Jun. 24, 2005

(51) Int. Cl. H04N 17/02; H04N 3/26

(52) U.S. Cl. 348/189; 348/745

(57) ABSTRACT

A video projection calibration technique includes a first camera to view the video display screen from the projector side, and a second camera to view the video display screen from the viewing side. The first camera may be a lower resolution than the second camera. The combination of the two cameras permits the transfer functions of the projection system and the first camera to be characterized and reduced to a warping transform that may be stored by the control system. The presence of the warping transform would permit the lower resolution, first camera to perform image realignment after the video projection system is in use by an end user.

### FIELD OF THE INVENTIONS

The inventions described below relate the field of video projection and more specifically to calibration of video projection calibration systems.

### BACKGROUND OF THE INVENTIONS

It is economically advantageous to use an image warping system with thin-cabinet, large screen microdisplay rear projection monitors (such as televisions and the like that utilize LCOS, LCD, or DMD microdisplay projectors). In order to provide a crisp, distortion free image on a thin-cabinet (small depth) large screen rear projection monitor without the aid of an image warping system, very expensive optics are generally employed. This is driven by the need to produce a large image from a microdisplay imager only a half to one inch (diagonal) across, in the span of a foot or less. Very wide angle lenses are often required to do this. Lower cost large screen rear projection monitors that have lower-cost optics either cannot be thin-cabinet, to avoid distorting the image projected on to the monitor screen, or the image quality on the monitor screen is inferior to that of a more expensive system using better optics.

Image warping systems negate the need for expensive optics by pre-warping an image from a video input device (such as a television tuner, DVD player, or the like) before the image is projected onto the monitor screen. The pre-warped image effectively counters the warping caused by the lower cost optics, or other elements in the image path, employed on the thin-cabinet, large screen rear projection monitor. The pre-warped image, after being projected through optics that warp it again, accurately displays the image expected from the input device when displayed on the monitor screen.

Image warping systems generally require a warping map also known as a warping transformation, that relates which pixel(s) of the microdisplay imager display relate to which portion(s) of an input image in order to produce the pre-warped image. Generating a warping map can be done by using ray-tracing optical software to make a baseline warping map and then fine-tuning the warping map using a digital camera and a computer. Loose manufacturing tolerances and other factors may cause each large screen rear projection monitor to require different warping transformations. For example, differences in alignment between optical elements may affect how an image is warped. Therefore, it may be necessary to calibrate each unit's warping map during manufacture.

A dual cameral calibration system may be used to calibrate projection video display devices at the time of manufacture. The external camera is generally a high resolution (2 megapixel or greater) digital camera that is placed in front of the video display device to be calibrated, in a position allowing the camera to see the whole screen. A computer is connected to both the large screen rear projection monitor and the camera. The warping map may be fine-tuned and corrected by having the computer command the large screen rear projection monitor to display a known picture or pattern on the monitor screen, and then having the camera take a picture of the image on the screen. By comparing the original, un-warped image to the image captured by the camera, the computer can calculate the distortion effects still unaccounted for by the warping map, and thereby create a highly accurate final warping map.

In addition to this factory-level, camera-based warping map generation, it is also advantageous to have a system built in to the television that allows a consumer or a field technician to fine-tune or “touch-up” the warping map. This permits a video projection unit to be calibrated in the field. Shipping and handling a large screen rear projection monitor may cause optical components to shift or move out of alignment, and environmental effects (humidity, temperature changes, and the like) can also cause these problems. These alignment problems may cause projected images to shift on-screen (either up-down, left-right, or rotationally). Obviously, these effects are still objectionable to the consumer. Rather than require that a consumer ship the large screen rear projection monitor back to the factory to recalibrate the warping map to fix the image shift or have a repair crew perform the service, it is desirable to provide the monitor with a self-diagnostic system that a consumer may simply activate when projected images look wrong, or that the system can automatically activate as a periodic calibration measure. This self-diagnostic system consists of a digital camera or image sensor(s) placed inside the large screen rear projection monitor cabinet such that it can view the back surface of the monitor screen (the surface on to which the microdisplay projector projects images). This camera is linked to the on-board control system that store and administer the warping map. The self-diagnostic system operates similarly to the factory level warping map generation. The on-board electronics command the large screen rear projection monitor to display a known image, and then have the camera in back of the monitor screen take a picture of the image on the monitor screen. The on-board electronics then compare the known image to the image captured by the camera in order to spot discrepancies, and thereby calculate the amount an image has shifted relative to the screen. Additionally, the electronics may use features in the incoming video being displayed to serve as the patterns for the calibration process.

Because a good initial map is known, the camera and electronics that comprise this self-diagnostic system do not have to be very sophisticated. The electronics do not need to regenerate the warping map from first principles, but rather only has to calculate how to adjust the image displayed by the imager in order to optimize the image on screen. Thus, including such a system on the large screen rear projection monitor is still economically advantageous over using expensive, precise optics. The camera or image sensor(s) included in the large screen rear projection monitor can be relatively low-resolution (1.3 megapixel or less) and use low-cost optics. The camera inside the cabinet of the large screen rear-projection monitor sits very close to the back of the monitor screen (due to the monitor being a thin-cabinet design) and thus must use a very wide angle lens, or even a fish-eye lens, in order to see the entire area of the large screen. In order for this self-diagnostic system to operate properly, however, it may be necessary to establish the position and mapping of pixels in images taken by the in-monitor camera to pixels projected by the microdisplay projector on to the monitor screen.

### SUMMARY

A dual camera calibration device and method, utilized in a large screen rear projection monitor with an image warping distortion correction system, allows a low cost, low resolution camera located inside the large screen rear projection monitor to properly reference images displayed by the monitor. Calibration may be performed using a high resolution camera set up in a known position relative to the large screen rear projection monitor and aimed at the front viewing surface of the monitor screen. Images captured by the high resolution camera outside of the monitor are compared to images captured by the low resolution camera inside the monitor, in order to ascertain the correspondence between pixels in the images captured by the low-resolution camera to pixels displayed on the large screen rear projection monitor. This correspondence is saved as a mapping function in the on-board electronics of the large screen rear projection monitor.

A video projection calibration system including a video display screen having a display side and a projection side, projection means for projecting one or more images on the projection side of the display screen, a first imaging means for capturing one or more projected images from the projection side of the video display screen, a second imaging means for capturing one or more projected images from the display side of the video display screen, and control means for comparing the one or more captured images from the first imaging means with the one or more captured images from the second imaging means and creating a warping map, the control means using the warping map to pre-warp the one or more images.

A method for calibrating a projection video display including the steps of projecting an image on a projection side of video display screen, the image also visible from a display side of the video display screen, and capturing a first image of the projected image from a the display side of the video display screen, and capturing a second image of the projected image from a the projection side of the video display screen, and comparing the first and second images to form a warping transform, and storing the warping transform, and pre-warping one or more images using the warping transform, and projecting the one or more pre-warped images on the projection side of the video display screen.

A video projection calibration technique includes a first camera to view the video display screen from the projector side, and a second camera to view the video display screen from the viewing side. The first camera may be a lower resolution than the second camera. The combination of the two cameras permits the transfer functions of the projection system and the first camera to be characterized and reduced to a warping transform that may be stored by the control system. The presence of the warping transform would permit the lower resolution, first camera to perform image realignment after the video projection system is in use by an end user.

### BRIEF DESCRIPTION OF THE DRAWINGS

FIG. 1 is a side view block diagram of a rear projection video display including a dual camera calibration system.

FIG. 2 is a cross section view of the calibration system of FIG. 1.

FIG. 3A is an image captured by camera 25 for mapping pixels.

FIG. 3B is an image captured by camera 22 for mapping pixels.

FIG. 4 is another image captured by camera 22.

FIG. 5 is another image captured by camera 25.

FIG. 6 is still another image captured by camera 25.

FIG. 7 is still another image captured by camera 22.

FIG. 8 is yet another image captured by camera 25.

### DETAILED DESCRIPTION OF THE INVENTIONS

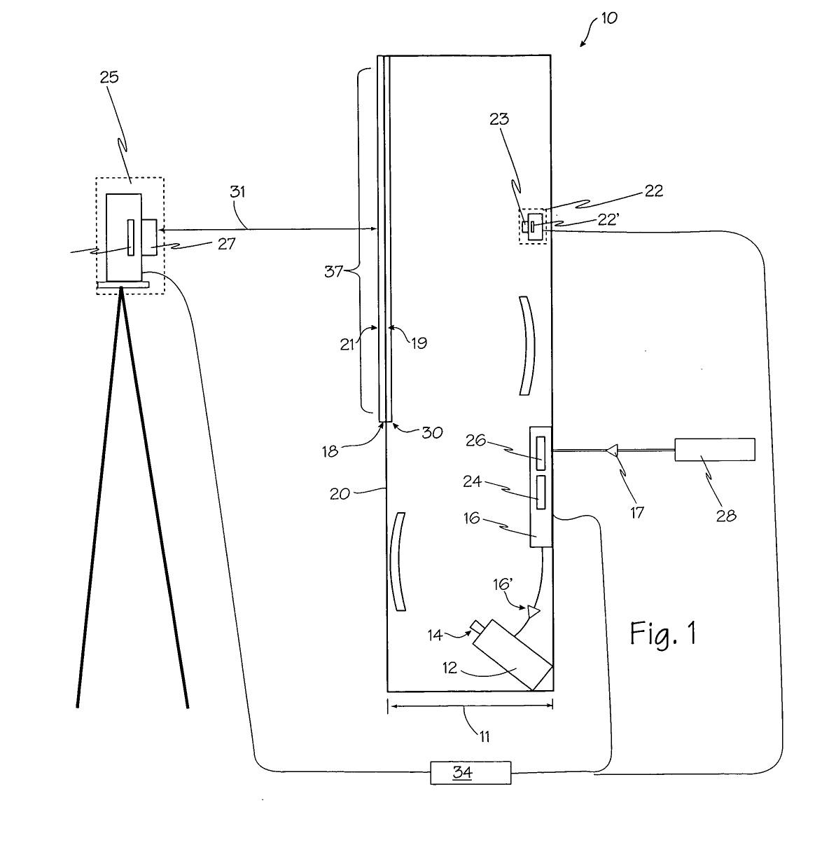

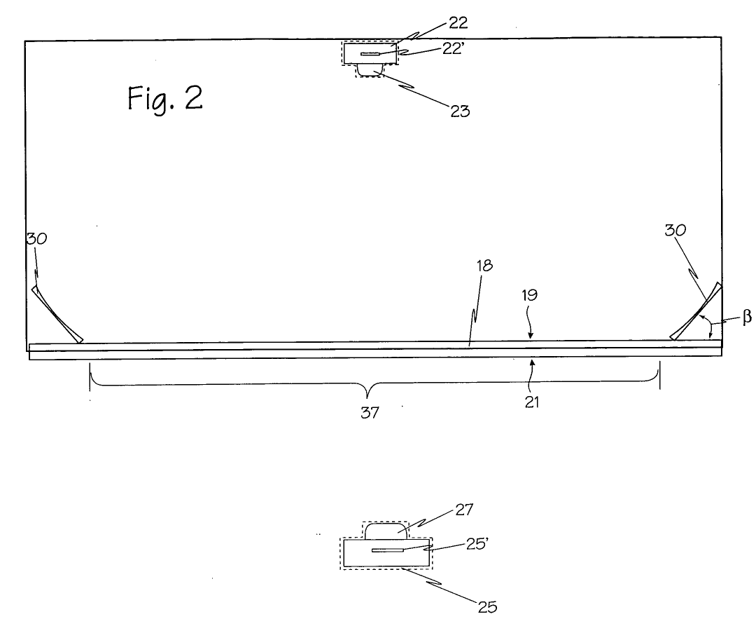

With reference to FIGS. 1 and 2, rear projection monitor 10 includes projector 12, projection optics 14, control system 16, viewing screen 18, cabinet 20 and low resolution camera 22. Rear projection monitor 10 is of a thin type, meaning that the depth of cabinet 20, represented by distance 11 may be less than fourteen inches. Rear projection monitor 10 may be used, for example, as a television, a home cinema, or the like. Projector 12 is generally mounted below the center horizontal axis of viewing screen 18 and projects upwards, off-axis. Any other suitable orientation of projector 12 may be used. Projector 12 is setup to receive signals from control system 16. The illustrated projector may incorporate a single microdisplay projector for use in a rear projection imaging system and thus may use a transmissive liquid crystal display (LCD) imager, a digital micromirror devices (DMD) imager, or a liquid crystal on silicon (LCOS) imager.

The microdisplay imager in projector 12 may be an XGA microdisplay, meaning that the display contains 786432 electronically controlled pixels arrayed in a grouping of 768 rows by 1024 columns. The operation of an XGA microdisplay projector is familiar to those of skill in the art, any other suitable display projector may be used. For example, projector 12 may be a non-single microdisplay projector with resolution greater or less than XGA. For the purposes of helping generate the warping transformation used by rear projection monitor 10 and for calibrating low resolution camera 22, high resolution camera 25 and computer 32 are located outside rear projection monitor 10. Note that the distances and relative size of objects in the Figures are not to scale.

A projected image radiates from projector 12 through projection optics 14. Although projection optics 14 are shown schematically in FIG. 1 as a single lens, projection optics 14 may include multiple lenses, mirrors, and other optical devices. Projection optics 14 projects an image from projector 12 on to rear surface 19 of screen 18. Screen 18 is transmissive so that the image projected on to surface 19 may be clearly be seen by viewers looking at front surface 21. Screen 18 may be, for example, a Fresnel lens and diffuser or any other suitable diffusive screen material.

Control system 16 is responsible for receiving signals 17 from a video input device such as input device 28, calculating how to warp images formed from signals 17 and creating a warping transform or map, re-sampling the warped images to convert them to a pixel based images, and turning the corresponding microdisplay pixels on and off in order to display an image. Control system 16 may also store the mapping function between the pixels displayed on viewing screen 18 and the pixels in images captured by low resolution camera 22. Control system 16 may also include electronic processor 24 and memory 26. Processor 24 may include integrated circuits, a central processing unit (CPU), or the like. Memory 26 is non-corruptible rewriteable memory such as flash, or the like, and may be used to store warping transformations, mapping functions, and reference images.

Warping transformations are mappings that determine how each portion of an input image is used to create an output image. Mapping functions correlate, or map, between images captured by low-resolution camera 22 and the actual pixels modulated by projector 12 and displayed on viewing screen 18. Although in this configuration, a warping transformation is executed prior to the image re-sampling process, a warping transformation may also be executed integrally with the re-sampling process or with any other suitable timing.

Control system 16 may be configured to receive video signals 17 from input source 28, such as a television tuner, digital versatile disk (DVD) player, or the like. Video signals 17 may correspond to desired display images. Processor 24 calculates how to map the images based on the warping transformation stored in memory 26. After calculating how to warp an image, processor 24 creates a warped image and commands specific pixels on the microdisplay in projector 12 to turn on or off, causing the microdisplay to display the warped images that the processor just calculated. These images are then transmitted optically to projection optics 14, which distort the images as they are displayed on viewing screen 18 that looks like the original source image from input source 28. The combined result of the pre-warping done by the microdisplay and the counter distortion from the projection optics is a relatively distortion free picture displayed on viewing screen 18. Control system 16 may also be configured to accept instructions or commands from outside electronics, such as an external computational unit or the like.

The warping transformation stored in memory 26 may only include imager pixels necessary for displaying image pixels that fall within viewing area 37. Pixels on the microdisplay imager that do not project pieces of a picture on to viewing area 37 may not covered by the pre-warping transformation.

In a dual camera calibration technique for projection video displays, the warping transformation stored in memory 26 includes a limited number of imager pixels that display image pixels outside the border of viewing area 37. For example, the warping transformation may cover imager pixels that project image pixels ten pixels beyond each border of viewing area 37.

Low resolution camera 22 is configured to electronically share information with control system 16. Low resolution camera 22 is a modest resolution digital camera, such as those manufactured by Micron. It is possible to replace low resolution camera 22 with an image sensor or any other suitable image capture device. Camera 22 is located inside cabinet 20 and is oriented to view surface 19 of viewing screen 18. Although camera 22 is located directly behind viewing screen 18 and is oriented substantially perpendicular to the screen, other suitable orientations of camera 22 may also be used. Camera 22 includes lens 23. Lens 23 may be a fisheye lens, a wide angle lens, or the like, that enables low resolution camera 22 to see substantially the entirety of viewing area 37 of viewing screen 18.

Viewing screen 18 may also include reference markers 30 for the purposes of aiding camera calibration with respect to viewing screen 18. Reference markers 30 may be thin rectangular strips of any suitable material that extend out from viewing screen 18 by approximately half an inch. They are preferably flat light gray or dark in color. These reference markers may line the periphery of viewing area 37 of viewing screen 18 and may be substantially perpendicular to viewing screen 18. They are also located inside cabinet 20, on the same side as surface 19. Reference markers 30 may have any suitable shape or color and occupy different orientations with reference to viewing screen 18. For example, in an alternate configuration, reference markers 30 do not form a continuous border around viewing area 37 but rather only occupy the middle ½ of each border. Also, the reference marker on each border of viewing area 37 may be oriented at angle β of 100 degrees relative to surface 19.

High resolution camera 25 is a digital camera with at least a 2 megapixel resolution, such as the Digital EOS Rebel by Canon. It includes a lens 27 that is a standard Single Lens Reflex (SLR) type lens. A high resolution camera 25 is positioned so that it is located four feet, as represented by distance 31, in front of the middle of front surface 21 of viewing screen 18, with high resolution camera 25 substantially perpendicular to viewing screen 18. In this position high resolution camera 25 is capable of viewing all of surface 21 of viewing screen 18. Any other suitable positions and angles of orientation of camera 25 may be used.

High resolution camera 25 may be electronically linked to computer 34, so that it can send information to the computer and also receive instructions from the computer. Computer 34 is also electronically linked to control system 16 and low resolution camera 22 and is able to send commands, receive information, and write functions to the control system 16 and low resolution camera. Computer 34 and high resolution camera 25 may only present for the initial factory calibration of both the warping transformation and the dual camera calibration.

With continuing reference to FIGS. 1 and 2, the dual camera calibration method begins following completion of the warping transformation generation. At this point, computer 34 will have obtained, through images from high resolution camera 25, a warping transformation that may be stored in memory 26 of control system 16. There are a number of suitable methods to obtain this warping transformation as is known in the art. As a result of this process, computer 34 has an accurate mapping function that correlates the pixels in images obtained from high resolution camera 25 to the pixels of images seen on front surface 21 of viewing screen 18.

Computer 34 then commands control system 16 to project a known image on to viewing screen 18. This known image may be a regular picture, a geometric pattern like a checkerboard, or the like. Control system 16 may, pre-warp the known image according to the warping transformation stored in memory 26, and then cause projector 12 to project the pre-warped image through projection optics 14 on to surface 19 of viewing screen 18, resulting in an undistorted image on the viewing screen. Computer 34 may then instruct high resolution camera 25 and low resolution camera 22 to each capture an image of the known image on viewing screen 18. Computer 34 then compares the images obtained from the two cameras.

In a configuration including reference markers 30, computer 34 may be able to quickly establish the borders of viewing area 37 of viewing screen 18 by finding the uniform edge surrounding the known image. This allows the computer to more easily ascertain the location of low resolution camera 22 with reference to viewing screen 18. In an alternate configuration, where surface 19 is not bordered by reference markers 30, finding the edge of the image taken by low resolution camera 22, and thus calculating the position of low resolution camera 22, is more difficult due to the extremely acute angle between the edge of viewing area 37 and lens 23.

After or during capture of images by cameras 22 and 25, computer 34 may then correlate pixels between the images obtained from the two cameras. This is not a simple reassigning of pixels, however; for example, if high resolution camera 25 is a six megapixel camera and low resolution camera 22 is a 1.3 megapixel camera, there is not simply a 2.23:1 correlation (horizontal and vertical) between pixels from the high resolution image to pixels in the low resolution image. This is due to the differences in lenses; because high resolution camera 25 is far from front surface 21, it can take fairly flat, nearly undistorted pictures of that surface. Low resolution camera 22, on the other hand, will almost always produce distorted images due to it being very close to the surface it takes pictures of and the need for an extremely wide angle lens or even a fish-eye lens.

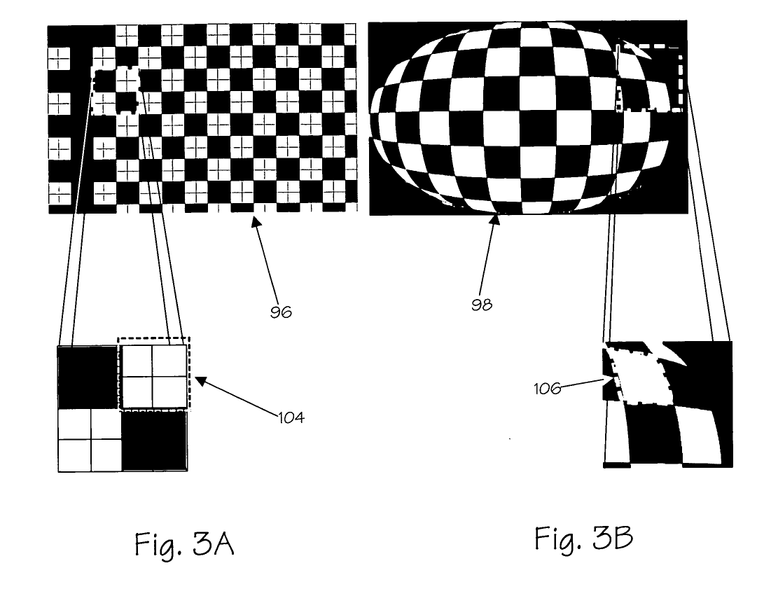

Referring now to FIGS. 3A and 3B, an explicatory example of mapping of pixels between images taking by the two cameras is illustrated. Image 96 is representative of a portion of an image that could be taken by high resolution camera 25, and image 98 is representative of a portion of an image that could be taken by low resolution camera 22. Note that the images are flipped horizontally relative to each other due to the two cameras being on opposite sides of the screen. Computer 34 would pick out corresponding pixels or groups of pixels within the two images and would map the locations from one to the other. For example, computer 34 would recognize that the pixels within area 104 of image 96 map to the pixel in area 106 of image 98. At the end of the correlation process, computer 34 will have mapped the location of all the pixels from images taken by low resolution camera 22 by correlating them to pixels in images from high resolution camera 25. By combining this map with the map it already has locating pixels from high resolution camera 35 to pixels in images displayed on viewing screen 18, computer 34 may generate a mapping function that provides a correspondence between the pixels in images displayed on viewing screen 18 and pixels in images taken by low resolution camera 22. Computer 34 then stores this mapping function in memory 26. These maps can be finer than a single pixel using interpolation methods.

In practice, when a home user activates the self-diagnostic test built into rear projection monitor 10, control system 16 uses a known image, pre-warps the known image according to the warping transformation stored in memory 26, and then cause projector 12 to project the pre-warped known image through projection optics 14 on to surface 19 of viewing screen 18, resulting in an image on the viewing screen. Control system 16 may then cause camera 22 to capture a picture of the image displayed on surface 19. Control system 16 then compares the locations of the pixels displayed on surface 19 by applying the mapping function to the image captured by low resolution camera 25. By comparing the results from this operation to the original, known image, control system may determine if images being projected on to viewing screen 18 are properly located, oriented, or otherwise distorted. If projector 12 and projection optics 14 are out of alignment and are projecting in the wrong area of viewing screen 18, or otherwise distorting projected images, control system 16 may adjust the warping transformation accordingly to correct the problem.

One of the advantages of having a warping function that extends to imager pixels that are not normally displayed within viewing area 37 is that a self-diagnostic test can run more efficiently for pictures just slightly out of alignment. For example, suppose the warping transformation extends to pixels ten deep beyond each border of viewing area 37, and the center of a picture is shifted five pixels to the left of the center of viewing area 37 due to misalignment. A picture displayed within viewing area 37, though its center is shifted, still looks undistorted because the new picture area shifted into the viewing area is pre-warped by the warping transformation, thereby appearing undistorted when it is finally displayed in viewing area 37. If a self-diagnostic test is run at this point, control electronics 16 will have little difficulty in discerning the amount the system is out of alignment, because no part of the known image displayed in viewing area 37 will appear distorted. The only distortion recognizable, is the distortion visible in the pictures taken by low resolution camera 22 through lens 23. That margin distortion is accounted for by the mapping function stored in memory 26. An additional advantage of having a warping function that extends to imager pixels that do not normally display picture pixels within viewing area 37 is that it decreases the need to run a self-diagnostic test if the system becomes only slightly out of alignment. As long as a picture completely fills the screen, and the picture looks undistorted, a consumer will not feel that anything is wrong with the rear projection monitor.

The task of re-centering or re-aligning a picture becomes more complicated if the warping transformation only covers imager pixels that produce picture pixels that are displayed within viewing area 37. If projector 12 or projection optics 14 become misaligned, a non-pre-warped piece of a picture will get displayed in viewing area 37. Due to the distorting effects present between projector 12 and projection optics 14, this new area of picture will appear distorted when displayed within viewing area 37. If a self-diagnostic test is run at this point, control electronics 16 will have a difficult time recognizing the distorted portion of the picture; the pixels in the distorted portion of the image will not map correctly according to the mapping function, as applied to the image picture taken by low resolution camera 22. The control electronics will have to rely on recognizing the positions of pixels in the undistorted portion of the picture in order to discern the amount the picture has been shifted. In addition, if the warping transformation only covers imager pixels that create image pixels displayed in viewing area 37, any tiny misalignment of the projection components outside of the factory will cause distorted portions of the picture to become visible in viewing area 37.

A possible complication when aligning low resolution camera 22 to high resolution camera 25 is eliminating artifacts present in images captured by low resolution camera 22 but not in images captured by high resolution camera 25. These artifacts are troublesome because it makes it difficult to map pixels from one image to another due to the artifacts obscuring groups of pixels. Imaging artifacts often result if viewing screen 18 is a Fresnel lens. The Fresnel lens reflects and refracts light along the imaginary line between lens 23 and projection optics 14. If both low resolution camera 22 and projection optics 14 are located along the center of viewing screen 18, then a bright line will be present in the center of images captured by low resolution camera 22 wherever bright pixels in that image are located.

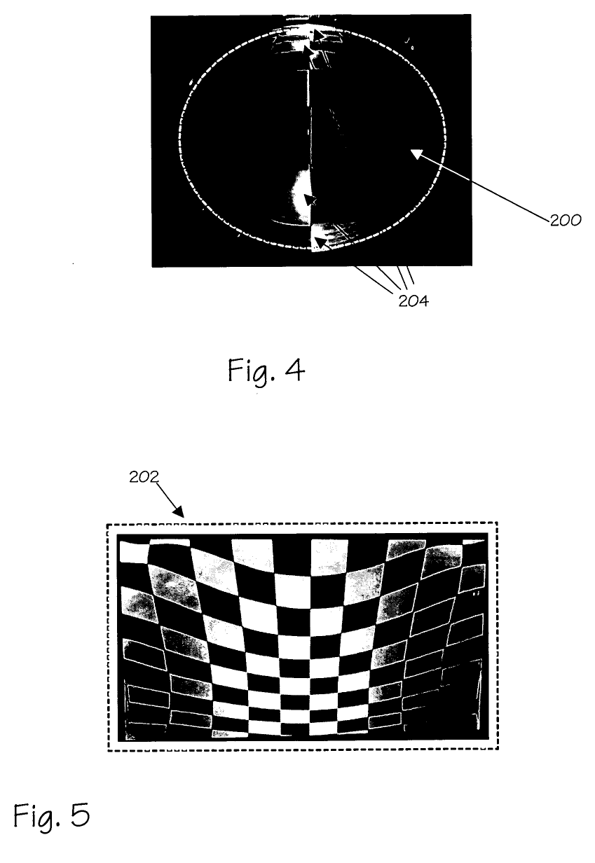

Referring now to FIG. 4, image 200 captured by a low resolution camera aimed at the back surface of a rear projection monitor viewing screen is illustrated. Lens 23 is a fish-eye lens.

Referring now to FIG. 5, image 202 captured by a high resolution camera aimed at the front surface of a rear projection monitor viewing screen is illustrated. Image 202 and image 200 were captured when projector 12 was projecting the same picture on viewing screen 18. The picture projected by projector 12 was not pre-warped before being projected, thus resulting in the distorted checker-board pattern present in image 202. Bright spots 204 result along the center of image 200 due to the specular reflection of light from projection optics 14 off surface 19 of viewing screen 18. Note that the black parts of the check-board image do not contain bright spots, as the black parts of the image are created by turning off imager pixels in that vicinity. No light is projected on to the screen in that particular area of the image, so no light from that area can be reflected by the screen. The bright spots are not present in image 202 because high resolution camera 25 is on the other side of viewing screen 18, capturing pictures of front surface 21. Bright spots 204 are undesirable because pixels in image 200 where bright spots 204 are located are obscured by the bright spots. Computer 34 is thereby unable to map those pixels in image 200 to the matching pixels in image 202.

The calibration image projected by projector 12 contains dark (off) pixels in the area of the screen that normally reflects light at low resolution camera 22. Thus, if no light is projected on the screen in the area where the screen reflects light, then light cannot reflect on to low resolution camera 22 and create bright spots in the images it captures. In the explicatory case illustrated in FIG. 4, this would mean projecting an image with a dark stripe down the center of the image. The dark stripe would be created by turning the imager pixels off that project in that area of the screen.

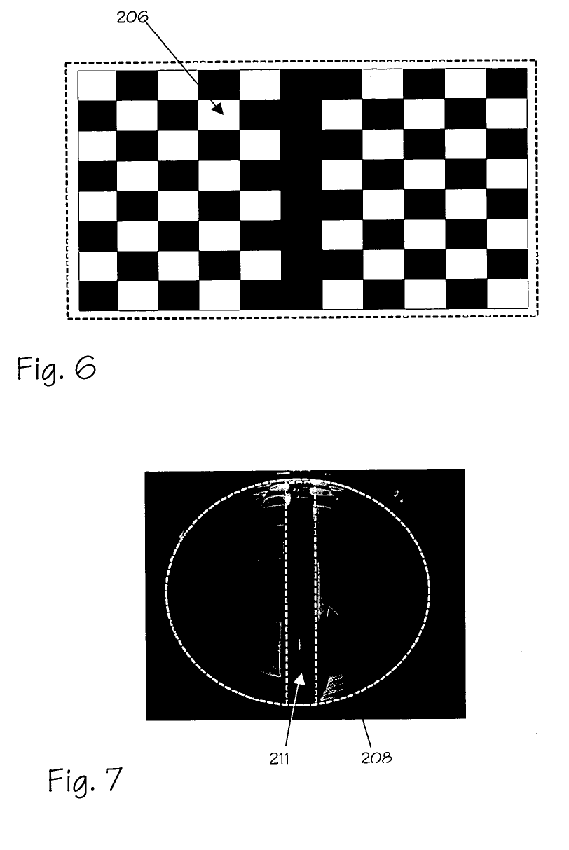

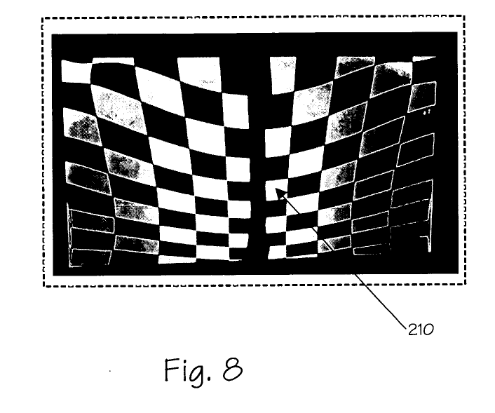

Referring now to FIGS. 6, a portion of a possible calibration image 206 that avoids imaging artifact problems resulting from Fresnel reflections is illustrated. FIGS. 7 and 8 illustrate images captured by cameras 22 and 25, respectively, of the projection of image 206 on viewing screen 18. Dark stripe 211 in image 208 does not contain any bright spots because all the imager pixels in that area of the image are off and therefore do not reflect light. It is consequently straightforward for computer 34 to map pixels from image 208 to image 210 due to the lack of pixel-obscuring bright spots. These bright areas could be mapped separately by adjusting the low resolution camera shutter speed to image that portion of the screen.

Thus, while currently preferred configurations of the devices and methods have been described in reference to the environment in which they were developed, they are merely illustrative of the principles of the inventions. Other embodiments and configurations may be devised without departing from the spirit of the inventions and the scope of the appended claims.

We claim:

1. A video projection calibration system comprising:
a video display screen having a display side and a projection side;
projection means for projecting one or more images on the projection side of the display screen;
a first imaging means for capturing one or more projected images from the projection side of the video display screen;
a second imaging means for capturing one or more projected images from the display side of the video display screen; and
control means for comparing the one or more captured images from the first imaging means with the one or more captured images from the second imaging means and creating a warping map, the control means using the warping map to pre-warp the one or more images.

2. A method for calibrating a projection video display comprising:
projecting an image on a projection side of video display screen, the image also visible from a display side of the video display screen;
capturing a first image of the projected image from a the display side of the video display screen;
capturing a second image of the projected image from a the projection side of the video display screen;
comparing the first and second images to form a warping transform;
storing the warping transform;
pre-warping one or more images using the warping transform; and
projecting the one or more pre-warped images on the projection side of the video display screen.
